(19) United States
(12) Patent Application Publication
(10) Pub. No.: US 2026/0129679 A1
(43) Pub. Date: May 7, 2026

(54) COMMUNICATION METHOD AND COMMUNICATION SYSTEM

(71) Applicant: INSTITUTE FOR INFORMATION INDUSTRY, TAIPEI CITY (TW)

(72) Inventor: Yen-Chih Kuo, TAIPEI CITY (TW)

(21) Appl. No.: 18/963,787

(22) Filed: Nov. 29, 2024

(30) Foreign Application Priority Data
Nov. 4, 2024 (TW) 113142041

(51) Int. Cl. H04W 74/0816; H04W 24/10; H04W 74/08

(52) U.S. Cl. CPC H04W 74/0816; H04W 24/10; H04W 74/0866

(57) ABSTRACT

A communication method and a communication system are provided. The communication method includes: configuring a user equipment (UE) to communicate with a base station according to predetermined configuration data that defines a measurement gap (MG) transmission rule indicating a preconfigured transmission strategy or a competitive transmission strategy, and the base station allocates a plurality of periodic MGs and a plurality of transmission resources to each UE; configuring each UE to determine whether a current MG conflicts with any of the transmission resources when determining that the current MG occurs; in response to determining that the current MG conflicts with any of the transmission resources, utilizing the current MG for data transmission according to the MG transmission rule; and in response to determining that the current MG does not conflict with any of the transmission resources, utilizing the current MG to perform channel quality measurement.

### CROSS-REFERENCE TO RELATED PATENT APPLICATION

This application claims the benefit of priority to Taiwan Patent Application No. 113142041, filed on Nov. 4, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method and a system, and more particularly to a communication method and a communication system.

### BACKGROUND OF THE DISCLOSURE

According to the existing specifications of the 3rd generation partnership project (3GPP), due to mobility issues, the user equipment (UE) must perform channel quality measurements, such as reference signal received power (RSRP) and reference signal received quality (RSRQ), during configured periodic measurement gaps (MGs). During these measurement periods, transmission or reception is prohibited.

Additionally, under the current 3GPP specifications, the base station pre-allocates periodic uplink and downlink transmission resources to the UE to reduce frequent signal exchanges. When pre-configured uplink and downlink transmission resources, such as semi-persistent scheduling (SPS) or configured grant (CG), conflict with MGs, priority is given to the channel quality measurements.

However, in the face of the rapid development of immersive experience technologies such as extended Reality (XR), augmented reality (AR), virtual reality (VR), and cloud gaming, it is necessary to establish new communication mechanisms to meet users' demands for high-definition and low-latency. Wireless networks must ensure that bandwidth and communication resources, such as the PDU Set Delay Budget (PSDB), meet these requirements.

### SUMMARY OF THE DISCLOSURE

In response to the above-referenced technical inadequacies, the present disclosure provides a communication method and a communication system capable of flexibly switching decisions between measurement and transmission, thereby efficiently utilizing communication resources.

In order to solve the above-mentioned problems, one of the technical aspects adopted by the present disclosure is to provide a communication method applicable to a communication system including one or more user equipment (UEs) and a base station that are communicatively connected with one another, and the communication method includes: configuring the one or more UEs to communicate with the base station according to predetermined configuration data, wherein the predetermined configuration data defines a measurement gap transmission rule indicating a pre-configured transmission strategy or a competitive transmission strategy, and the base station pre-allocates a plurality of periodic measurement gaps and a plurality of transmission resources for each of the one or more UEs; and configuring each of the one or more of UEs to perform following processes: in response to determining that a current measurement gap occurs, determining whether the current measurement gap conflicts with any of the plurality of transmission resources; in response to determining that the current measurement gap conflicts with any of the transmission resources, utilizing the current measurement gap for data transmission according to the measurement gap transmission rule; and in response to determining that the current measurement gap does not conflict with any of the plurality of transmission resources, utilizing the current measurement gap to perform channel quality measurement.

In order to solve the above-mentioned problems, another one of the technical aspects adopted by the present disclosure is to provide a communication system, which includes a base station and one or more UEs communicatively connected to the base station. The one or more UEs are configured to communicate with the base station according to predetermined configuration data, the predetermined configuration data defines a measurement gap transmission rule indicating a pre-configured transmission strategy or a competitive transmission strategy, and the base station pre-allocates a plurality of periodic measurement gaps and a plurality of transmission resources for each of the one or more UEs. Each of the one or more UEs is configured to perform following processes: in response to determining that a current measurement gap occurs, determining whether the current measurement gap conflicts with any of the plurality of transmission resources; in response to determining that the current measurement gap conflicts with any of the transmission resources, utilizing the current measurement gap for data transmission according to the measurement gap transmission rule; and in response to determining that the current measurement gap does not conflict with any of the plurality of transmission resources, utilizing the current measurement gap to perform channel quality measurement.

Therefore, in the communication method and communication system provided by the present disclosure, under the pre-configured transmission strategy, the base station can allocate periodic measurement gaps for the user equipment (UE) to transmit data, addressing the issue of insufficient transmission resources. When there is no need for data transmission between the UE and the base station, the transmission resources can be reallocated to other UEs. On the other hand, under the competitive transmission strategy, the base station allows the UEs to compete for the measurement gaps and transmit data, which enables precise allocation for the measurement gaps when the UE has actual data transmission needs, thereby addressing the issue of insufficient transmission resources.

Furthermore, in the communication method and communication system provided by the present disclosure, the UE can also decide to utilize the measurement gap for data transmission or channel quality measurement based on the remaining data delay budget and the time or frequency of data transmission during the measurement gap. This approach balances resource utilization and measurement, preventing connection interruptions between the base station and the UE while increasing data transmission resources.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a communication system according to one embodiment of the present disclosure.

FIG. 2 is a schematic diagram illustrating the pre-allocation of periodic uplink and downlink transmission resources to the user equipment by the base station under the existing 3GPP specifications.

FIG. 3 is a first flowchart of a communication method according to one embodiment of the present disclosure.

FIG. 4 is a second flowchart of the communication method according to one embodiment of the present disclosure.

FIG. 5 is a third flowchart of the communication method according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

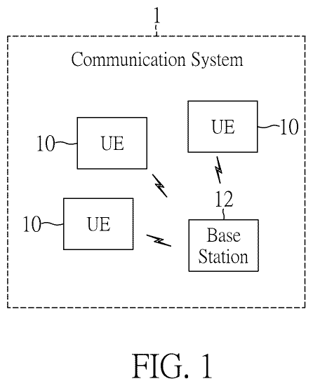

FIG. 1 is a schematic diagram of a communication system according to one embodiment of the present disclosure. As shown in FIG. 1, a communication system 1 includes one or more user equipment (UEs) 10 and a base station 12. The UEs 10 can communicate with the base station 12. The base station 12 can be a core network device that includes processors and memory. Each UE 10 can be a device that includes one or more processors or memory, such as a mobile phone, a wearable device, an Internet of Things (IoT) device, a tablet, a desktop computer, a laptop, or a wireless terminal device that support immersive experience technologies like extended reality (XR), augmented reality (AR), virtual reality (VR), and a cloud gaming, but the present disclosure is not limited thereto.

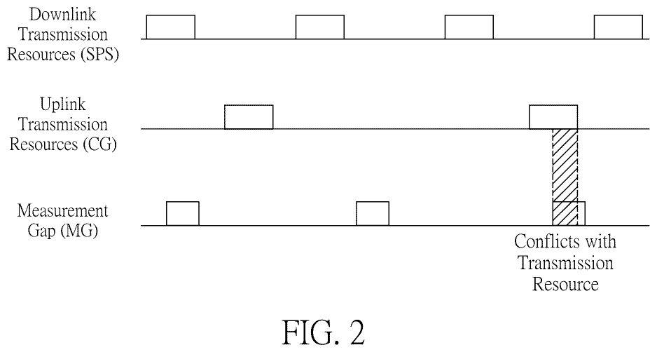

FIG. 2 is a schematic diagram illustrating the pre-allocation of periodic uplink and downlink transmission resources (TRs) to the UE by the base station under the existing 3GPP specifications. As shown in FIG. 2, for the UE 10 that needs to perform channel quality measurement based on a measurement gap (MG), communications (e.g., pre-configured uplink and downlink TRs such as semi-persistent scheduling (SPS) or configured grant (CG)) with a base station 12 are suspended on the configured MG, and the channel quality measurements such as reference signal received power (RSRP) and reference signal received quality are performed.

However, for wireless terminal devices supporting technologies such as XR, AR, VR, and cloud gaming, most usage scenarios are indoors with shorter movement distances. Therefore, it is possible to conditionally reduce the frequency of channel quality measurements without compromising communication quality. The communication method and the communication system 1 of the present disclosure, under this premise, prioritize transmission over measurement when the pre-configured TRs conflict with the MGs, allowing the UE 10 to acquire more TRs. To ensure signal quality, mandatory signal measurements are also conducted under specific conditions.

Therefore, in the embodiment of the present disclosure, the UE 10 and the base station 12 communicate according to predetermined configuration data. The predetermined configuration data defines a measurement gap (MG) transmission rule, and the base station 12 can determine which of the uplink and downlink TRs can be utilized for data transmission when there is a conflict with the MGs.

The MG transmission rule can instruct the UE 10 and the base station 12 to utilize the MG under a pre-configured transmission strategy or a competitive transmission strategy. For the pre-configured transmission strategy, when performing the configuredgrantconfig/SPSconfig of the radio resource configuration (RRC), the base station 12 (e.g., gNodeB) can determine which configurations can be utilized for data transmission when a conflict occurs with the MG. More specifically, during the RRC measgapconfig configuration, the base station 12 can determine whether the UE 10 is allowed to transmit data in the MG, and if affirmative, describe the resource configuration. Under the competitive transmission strategy, multiple UEs 10 can report to the base station 12 through the buffer status reports (BSR) or the delay status reports (DSR). When conflicts arise between uplink and downlink TRs and MGs, the reports can include indication information on whether to utilize the MG for data transmission. When the base station 12 receives a report from the UE 10 indicating a request for utilizing the MG for data transmission, the base station 12 allocates the corresponding MG to the UE with data transmission needs.

Additionally, to ensure communication quality, both pre-configured and competitive transmission strategies require a configuration of a timer or a counter. When the UE 10 utilizes the MG for data transmission and reaches a certain time or count limit, mandatory measurements must be conducted.

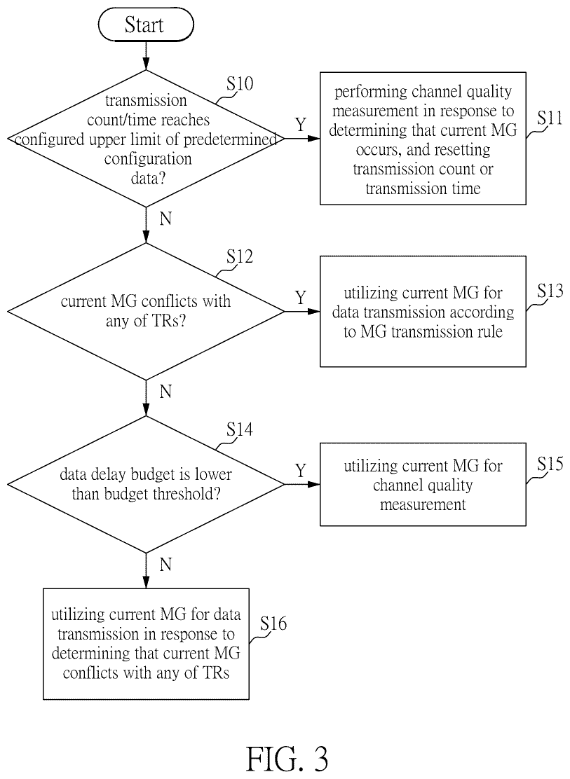

FIG. 3 is a first flowchart of a communication method according to one embodiment of the present disclosure. Referring to FIG. 3, one embodiment of the present disclosure provides a communication method, which at least includes configuring each UE 10 to execute the following steps.

Step S10: determining whether a transmission count or a transmission time reaches a configured upper limit of the predetermined configuration data. For example, a timer or a counter can be used to start timing or counting (counting the number of times the MG is utilized for data transmission) after the previous channel quality measurement. The upper limit is configured as a predetermined time or count limit.

In response to determining in step S10 that the transmission count or the transmission time reaches the configured upper limit, the communication method proceeds to step S11: performing the channel quality measurement in response to determining that the current MG occurs, and resetting the transmission count or the transmission time.

In response to determining in step S10 that the transmission count or the transmission time does not reach the configured upper limit, the communication method proceeds to step S12: determining whether the current MG conflicts with any of the TRs.

In response to determining in step S12 that the current MG conflicts with any of the TRs, the communication method proceeds to step S13: utilizing the current MG for data transmission according to the MG transmission rule.

In response to determining in step S12 that the current MG does not conflict with any of the TRs, the communication method proceeds to step S14: determining whether a data delay budget is lower than a budget threshold. In the current 3GPP specification, all data has a delay budget, such as PDU set delay budget (PSDB). When the delay budget falls below a threshold, the UE 10 can report to the base station 12 to request upload resources. If the base station 12 has no resources available for allocation at that moment, the UE 10 will be unable to transmit, leading to the depletion of the delay budget and the subsequent discarding of packets. Therefore, in this step, it is necessary to monitor whether the data delay budget is insufficient. If the data delay budget falls below the threshold, the MG is not allowed to be utilized for data transmission. Therefore, the communication method proceeds to step S15: utilizing the current MG for channel quality measurement.

In response to determining that the data delay budget is not less than the budget threshold, the communication method proceeds to step S16: utilizing the current MG for data transmission in response to determining that the current MG conflicts with any of the TRs.

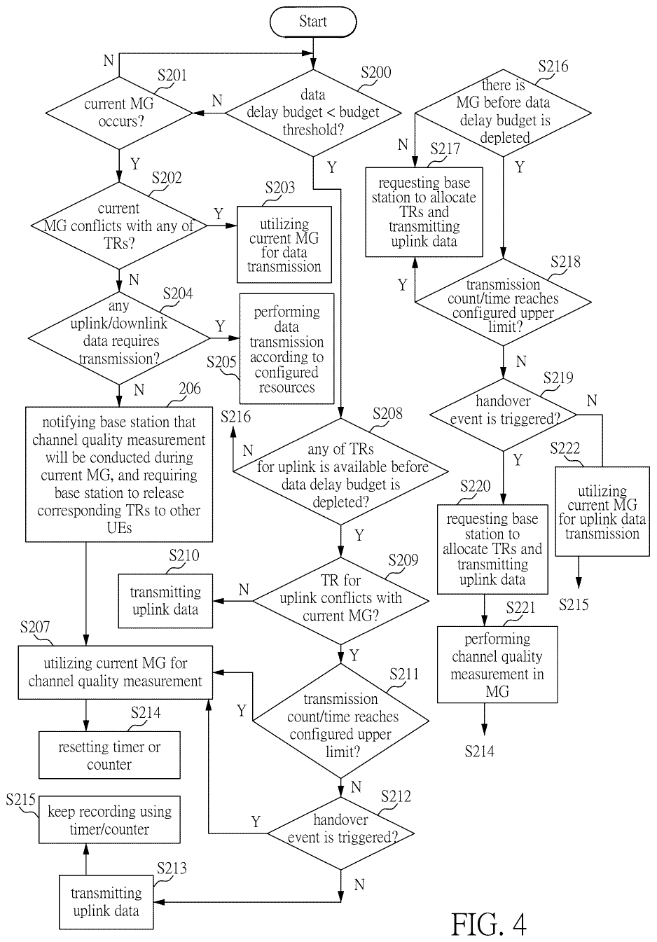

FIG. 4 is a second flowchart of the communication method according to one embodiment of the present disclosure. Referring to FIG. 4, the communication method provided by the present embodiment is performed based on FIG. 3, and the MG transmission rule indicates that the UE 10 and the base station 12 utilize the MGs under the competitive transmission strategy. In this situation, the base station 12 can pre-allocate periodic MGs for each UE 10, and these MGs can be utilized for data transmission. For different UEs 10, the MGs are staggered to avoid conflicts during data transmission.

Referring to FIG. 4, the communication method of this embodiment includes configuring each UE 10 to perform the following steps.

Step S200: determining whether a data delay budget is lower than a budget threshold.

In response to determining that the data delay budget is not less than the budget threshold in step S200, the communication method proceeds to step S201: determining whether a current MG occurs.

In response to determining in step S201 that the current MG occurs, the communication method proceeds to step S202: determining whether the current MG conflicts with any of the TRs.

In response to determining in step S201 that no current MG occurs, the communication method returns to step S200.

In response to determining in step S202 that the current MG conflicts with any of the TRs, the communication method proceeds to step S203: utilizing the current MG for data transmission.

In response to determining that the current MG does not conflict with any of the TRs, the communication method proceeds to step S204: determining whether any uplink data or downlink data requires transmission. In other words, whether the UE 10 has data to be transmitted to the base station 12 is determined, or whether the base station 12 has data to be transmitted to the UE 10 is determined.

In response to determining in step S204 that the uplink data or the downlink data requires transmission, the communication method proceeds to step S205: performing data transmission according to the configured resources.

In response to determining in step S204 that no uplink data or downlink data requires transmission, the communication method proceeds to step S206: notifying the base station that channel quality measurement will be conducted during the current MG, and requiring the base station to release TRs corresponding to the current MG to other UEs.

After step S206, the communication method proceeds to step S207: utilizing the current MG for the channel quality measurement.

In response to determining in step S200 that the data delay budget is lower than the budget threshold, the communication method proceeds to step S208: determining whether any of the TRs for uplink is available before the data delay budget is depleted. In step S208, the TRs for uplink can be, for example, configured grant (CG) resources.

In response to determining in step S208 that the TR for uplink is available before the data delay budget is depleted, the communication method proceeds to step S209: determining whether the TR for uplink conflicts with the current MG.

In response to determining in step S209 that the TR for uplink does not conflict with the current MG, the communication method proceeds to step S210: transmitting uplink data.

In response to determining in step S209 that the TR for uplink conflicts with the current MG, the communication method proceeds to step S211: determining whether the transmission count or the transmission time reaches the configured upper limit.

In response to determining in step S211 that the transmission count or the transmission time reaches the configured upper limit, the communication method proceeds to step S207: utilizing the current MG to perform the channel quality measurement.

In response to determining in step S211 that the transmission count and the transmission time do not reach the configured upper limit, the communication method proceeds to step S212: determining whether a handover event is triggered. According to the current 3GPP specifications, if the signal from the serving base station 12 weakens, an event trigger will occur. The UE 10 must then continuously measure the channel quality for a period of time to determine if a handover (HO) is necessary. However, if channel quality measurements are not conducted within the set time, the UE 10 may lose connection with the base station 12.

In response to determining that the handover event is triggered in step S212, the communication method proceeds to step S207: utilizing the current MG to perform the channel quality measurement.

In response to determining in step S212 that the handover event is not triggered, the communication method proceeds to step S213: transmitting uplink data.

It should be noted that in step S207, since the channel quality measurement has been performed, it is necessary to proceed to step S214: resetting the timer or counter.

In addition, in steps S205, S210 and S213, since the channel quality measurement is not performed utilizing the MG, the communication method proceeds to step S215: keep recording using the timer or the counter.

In response to determining in step S208 that no TR for uplink is available before the data delay budget is depleted, the communication method proceeds to step S216: determining whether there is MG before the data delay budget is depleted.

In response to determining in step S216 that there is no MG before the data delay budget is depleted, the communication method proceeds to step S217: requesting the base station to allocate TRs and transmitting uplink data. In this step, since there is no configured CG, SPS or MG available before the data delay budget is depleted, the UE 10 needs to request additional resources from the base station 12 for data transmission. In this situation, the base station 12 can allocate dynamic grant resources to the UE 10, allowing the UE 10 to transmit data before the data delay budget is depleted. This prevents the UE 10 from being unable to transmit data and the delay budget from being exhausted, which would result in packet loss.

In response to determining in step S216 that there is a MG before the data delay budget is depleted, the communication method proceeds to step S218: determining whether the transmission count or the transmission time reaches the configured upper limit.

In response to determining in step S218 that the transmission count or the transmission time reaches the configured upper limit, the communication method proceeds to step S217.

In response to determining in step S218 that the transmission count or the transmission time does not reach the configured upper limit, the communication method proceeds to step S219: determining whether a handover event is triggered.

In response to determining that the handover event is triggered in step S219, the communication method proceeds to step S220: requesting the base station to allocate TRs and transmitting uplink data, and the communication method proceeds to step S221: performing the channel quality measurement in the MG. Then, the communication method proceeds to step S214.

In response to the determining in step S219 that the handover event is not triggered, the communication method proceeds to step S222: utilizing the current MG for uplink data transmission, and then the communication method proceeds to step S215.

Therefore, in this embodiment, the base station 12 pre-configures periodic MGs for the UE 10 to transmit data, thereby addressing the issue of insufficient TRs. Furthermore, the UE 10 can also decide to utilize the MG for data transmission or channel quality measurement based on the remaining data delay budget and the time or frequency of data transmission during the MG. This approach balances resource utilization and measurement, preventing connection interruptions between the base station 12 and the UE 10 while increasing data TRs. When there is no need for data transmission between the UE 10 and the base station 12, the TRs can be reallocated to other UEs 10.

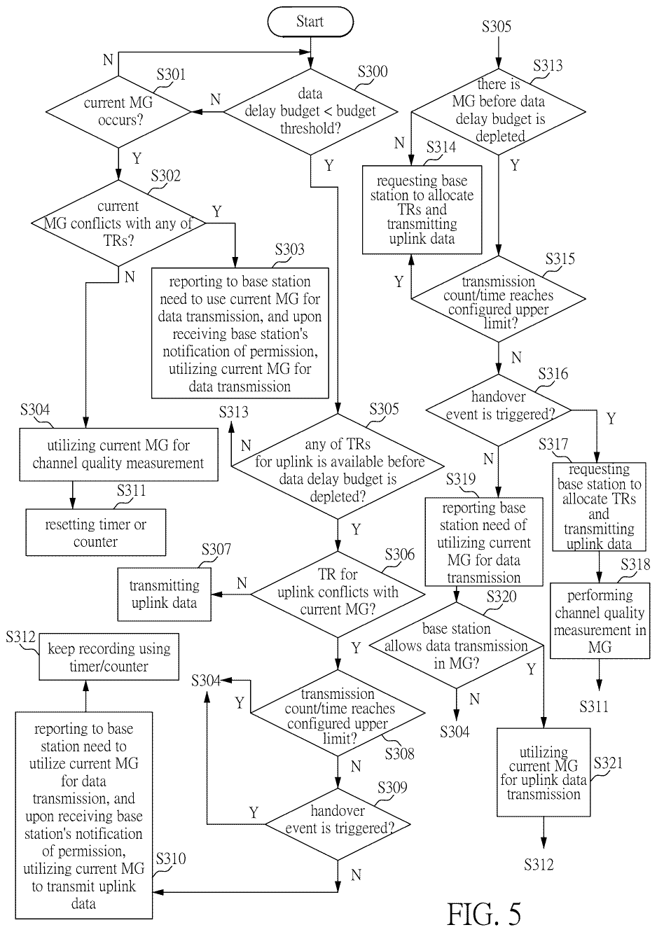

FIG. 5 is a third flowchart of the communication method according to one embodiment of the present disclosure. Referring to FIG. 5, the communication method provided in this embodiment is performed based on FIG. 3, and the MG transmission rule indicates that the UE 10 and the base station 12 utilize the MG under the competitive transmission strategy. In this case, the base station 12 can pre-configure the same MGs for each UE 10, and these MGs are not pre-configured to be available for the UE 10 to transmit data, but are open for different UEs 10 to compete for. In other words, the UE 10 with data transmission requirements can make a resource allocation request to the base station 12 to request to utilize the MG for data transmission. When the base station 12 replies that the MG is available, the MG can then be utilized for data transmission.

Referring to FIG. 5, the communication method of the present embodiment includes configuring each UE 10 to perform the following steps.

Step S300: determining whether a data delay budget is lower than a budget threshold.

In response to determining that the data delay budget is not less than the budget threshold in step S300, the communication method proceeds to step S301: determining whether a current MG occurs.

In response to determining in step S301 that the current MG occurs, the communication method proceeds to step S302: determining whether the current MG conflicts with any of the TRs.

In response to determining in step S301 that no current MG occurs, the communication method returns to step S300.

In response to determining in step S302 that the current MG conflicts with any of the TR, the communication method proceeds to step S303: reporting to the base station a need to utilize the current MG for data transmission, and upon receiving the base station's notification of permission, utilizing the current MG for data transmission. In this step, the UE 10 can include an indicator flag (e.g., a value of 1) in the delay status report (DSR) to inform the base station 12 of the need to utilize the MG for data transmission. Once the base station 12 grants permission and allocates the MG, the UE 10 can proceed with data transmission during the current MG upon receiving the notification.

In response to determining in step S302 that the current MG does not conflict with any of the TRs, the communication method proceeds to step S304: utilizing the current MG to perform the channel quality measurement.

In response to determining in step S300 that the data delay budget is lower than the budget threshold, the communication method proceeds to step S208: determining whether any of the TRs for uplink is available before the data delay budget is depleted. In step S305, the TR for uplink can be, for example, a configured grant (CG) resource.

In response to determining in step S305 that there is the TR for uplink before the data delay budget is depleted, the communication method proceeds to step S306: determining whether the TR for uplink conflicts with the current MG.

In response to determining in step S306 that the TR for uplink does not conflict with the current MG, the communication method proceeds to step S307: transmitting uplink data.

In response to determining in step S306 that the TR for uplink conflicts with the current MG, the communication method proceeds to step S308: determining whether the transmission count or transmission time reaches the configured upper limit.

In response to determining in step S308 that the transmission count or the transmission time reaches the configured upper limit, the communication method proceeds to step S304: utilizing the current MG to perform the channel quality measurement.

In response to determining in step S308 that the transmission count and the transmission time do not reach the configured upper limit, the communication method proceeds to step S309: determining whether a handover event is triggered.

In response to determining that the handover event is triggered in step S309, the communication method proceeds to step S304: utilizing the current MG to perform the channel quality measurement.

In response to determining in step S309 that the handover event is not triggered, the communication method proceeds to step S310: reporting to the base station a need to utilize the current MG for data transmission, and upon receiving the base station's notification of permission, utilizing the current MG to transmit uplink data.

It should be noted that in step S304, since the channel quality measurement has been performed, it is necessary to proceed to step S311: resetting the timer or counter.

In addition, in steps S303 and S310, since the channel quality measurement is not performed utilizing the MG, the communication method proceeds to step S312: keep timing using the timer or keep counting using the counter.

In response to determining in step S305 that no TR for uplink is available before the data delay budget is depleted, the communication method proceeds to step S313: determining whether there is MG before the data delay budget is depleted.

In response to determining in step S313 that there is no MG before the data delay budget is depleted, the communication method proceeds to step S314: requesting the base station to allocate TRs and transmitting uplink data. In this step, since there is no configured CG, SPS or MG available before the data delay budget is depleted, the UE 10 needs to request additional resources from the base station 12 for data transmission. For example, the UE 10 can send a dynamic data transmission request, such as including an indicator flag (e.g., a value of 0) in the DSR to inform the base station 12 that the UE 10 does not intend to utilize the MG for data transmission. This allows the UE 10 to request additional TRs from the base station 12. In this situation, the base station 12 can allocate TRs that do not conflict with any MG, such as dynamic grant (DG) resources to the UE 10, allowing the UE 10 to transmit data before the data delay budget is depleted. This prevents the UE 10 from being unable to transmit data and the delay budget from being exhausted, which would result in packet loss.

In response to determining in step S313 that there is a MG before the data delay budget is depleted, the communication method proceeds to step S315: determining whether the transmission count or the transmission time reaches the configured upper limit.

In response to determining in step S315 that the transmission count or the transmission time reaches the configured upper limit, the communication method proceeds to step S314.

In response to determining in step S315 that the transmission count or the transmission time does not reach the configured upper limit, the communication method proceeds to step S316: determining whether a handover event is triggered.

In response to determining that the handover event is triggered in step S316, the communication method proceeds to step S317: requesting the base station to allocate additional TRs and transmitting uplink data. Similarly, in this step, the UE 10 can include an indicator flag (e.g., a value of 0) in the DSR to inform the base station 12 of the need to utilize the MG for data transmission. Once the base station 12 grants permission and allocates the TRs, the UE 10 can proceed with uplink data transmission during the current MG upon receiving the notification. After step S317, the communication method proceeds to step S318: performing the channel quality measurement in the MG. Next, the communication method proceeds to step S311.

In response to the determining in step S316 that the handover event is not triggered, the communication method proceeds to step S319: reporting the base station a need of utilizing the current MG for data transmission.

In this step, the UE 10 can include an indicator flag (e.g., a value of 1) in the DSR to inform the base station 12 of the need to utilize the MG for data transmission.

Step S320: determining whether the base station allows data transmission in the MG.

In response to determining in step S320 that the base station 12 allows data transmission in the MG and allocates the MG, the UE 10 executes step S321: utilizing the current MG to transmit uplink data, and the communication method proceeds to step S312.

In response to determining in step S320 that the base station 12 does not allow data transmission in the MG, the UE 10 executes step S318. Next, the communication method proceeds to step S311.

Therefore, in this embodiment, by allowing the UEs 10 to compete for MGs and transmit data, the base station 12 can accurately allocate the MGs for the UEs having actual data transmission needs, thereby addressing the issue of insufficient TRs. Furthermore, the UE 10 can also decide to utilize the MG for data transmission or channel quality measurement based on the remaining data delay budget and the time or frequency of data transmission during the MG. This approach balances resource utilization and measurement, preventing connection interruptions between the base station 12 and the UE 10 while increasing data TRs.

In conclusion, in the communication method and communication system provided by the present disclosure, under the pre-configured transmission strategy, the base station can allocate periodic MGs for the UE to transmit data, addressing the issue of insufficient TRs. When there is no need for data transmission between the UE and the base station, the TRs can be reallocated to other UEs. On the other hand, under the competitive transmission strategy, the base station allows the UEs to compete for the MGs and transmit data, which enables precise allocation for the MGs when the UE has actual data transmission needs, thereby addressing the issue of insufficient TRs.

Furthermore, in the communication method and communication system provided by the present disclosure, the UE can also decide to utilize the MG for data transmission or channel quality measurement based on the remaining data delay budget and the time or frequency of data transmission during the MG. This approach balances resource utilization and measurement, preventing connection interruptions between the base station and the UE while increasing data TRs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A communication method, applicable to a communication system including one or more user equipment (UEs) and a base station that are communicatively connected with one another, the communication method comprising:
configuring the one or more UEs to communicate with the base station according to predetermined configuration data, wherein the predetermined configuration data defines a measurement gap transmission rule indicating a pre-configured transmission strategy or a competitive transmission strategy, and the base station pre-allocates a plurality of periodic measurement gaps and a plurality of transmission resources for each of the one or more UEs; and
configuring each of the one or more of UEs to perform following processes:
in response to determining that a current measurement gap occurs, determining whether the current measurement gap conflicts with any of the plurality of transmission resources;
in response to determining that the current measurement gap conflicts with any of the transmission resources, utilizing the current measurement gap for data transmission according to the measurement gap transmission rule; and
in response to determining that the current measurement gap does not conflict with any of the plurality of transmission resources, utilizing the current measurement gap to perform channel quality measurement.

2. The communication method according to claim 1, further comprising:
configuring each of the one or more UEs to perform:
determining whether a transmission count or a transmission time reaches a configured upper limit of the predetermined configuration data; and
in response to determining that the transmission count or the transmission time reaches the configured upper limit, performing channel quality measurement in response to determining that the current measurement gap occurs, and resetting the transmission count or the transmission time.

3. The communication method according to claim 2, further comprising:
configuring each of the one or more UEs to perform:
determining whether a data delay budget is lower than a budget threshold;
in response to determining that the data delay budget is not lower than the budget threshold, determining whether the current measurement gap occurs, and utilizing the current measurement gap for data transmission in response to determining that the current measurement gap conflicts with any of the plurality of transmission resources;
in response to determining that the data delay budget is lower than the budget threshold, determining whether any of the plurality of transmission resources for uplink is available before the data delay budget is depleted;
in response to determining that the data delay budget is not less than the budget threshold, determining whether the current measurement gap conflicts with any of the plurality of transmission resources;
in response to determining that any of the plurality of transmission resources for uplink is available before the data delay budget is depleted, performing the channel quality measurement when the current measurement gap occurs and the transmission count or the transmission time is determined to reach the configured upper limit; and
in response to determining that any of the plurality of transmission resources for uplink is not available before the data delay budget is depleted, utilizing the current measurement gap for data transmission in response to determining that the transmission count or the transmission time does not reach the configured upper limit.

4. The communication method according to claim 3, wherein the predetermined configuration data defines and indicates the pre-configured transmission strategy, and the communication method further comprises:
configuring each of the one or more UEs to perform:
in response to determining that the current measurement gap does not conflict with any of the plurality of transmission resources, determining whether any uplink data or downlink data requires transmission;
in response to determining that the uplink data or the downlink data requires transmission, transmitting the uplink data or the downlink data according to the plurality of transmission resources that are pre-configured; and
in response to determining that no uplink data or the downlink data requires transmission, utilizing the current measurement gap to perform the channel quality measurement, and notifying the base station to release the corresponding transmission resources.

5. The communication method according to claim 4, further comprising:
configuring each of the one or more UEs to perform:
in response to determining that the transmission count or the transmission time reaches the configured upper limit, determining whether a handover event is triggered;
in response to determining that the handover event is triggered, utilizing the current measurement gap to perform the channel quality measurement; and
in response to determining that the handover event is not triggered, utilizing the current measurement gap for uplink data transmission.

6. The communication method according to claim 3, wherein the predetermined configuration data defines and indicates the competitive transmission strategy, and the communication method further comprises:
configuring each of the one or more UEs to perform:
in response to determining that the transmission count or the transmission time reaches the configured upper limit, determining whether a handover event is triggered;
in response to determining that the handover event is triggered, transmitting a dynamic data transmission request to the base station, and utilizing the transmission resources that do not conflict with any of the measurement gaps for uplink data transmission; and
in response to determining that the handover event is not triggered, transmitting the dynamic data transmission request for utilizing the current measurement gap to the base station.

7. The communication method according to claim 6, wherein, in response to the UE receiving a notification from the base station for permitting transmission, the current measurement gap is utilized for data transmission; and
in response to the UE not receiving the notification from the base station for permitting transmission, the current measurement gap is utilized to perform the channel quality measurement.

8. The communication method according to claim 1, further comprising:
configuring each of the one or more UEs to perform:
in response to performing the channel quality measurement in the current measurement time slot, resetting a measurement gap timer or a measurement gap counter to zero; and
in response to the current measurement gap being utilized for data transmission, starting the measurement gap timer or increasing a measurement count of the measurement gap counter by 1.

9. A communication system, comprising:
a base station; and
one or more user equipment (UEs) communicatively connected to the base station;
wherein the one or more UEs are configured to communicate with the base station according to predetermined configuration data, the predetermined configuration data defines a measurement gap transmission rule indicating a pre-configured transmission strategy or a competitive transmission strategy, and the base station pre-allocates a plurality of periodic measurement gaps and a plurality of transmission resources for each of the one or more UEs; and
wherein each of the one or more UEs is configured to perform following processes:
in response to determining that a current measurement gap occurs, determining whether the current measurement gap conflicts with any of the plurality of transmission resources;
in response to determining that the current measurement gap conflicts with any of the transmission resources, utilizing the current measurement gap for data transmission according to the measurement gap transmission rule; and
in response to determining that the current measurement gap does not conflict with any of the plurality of transmission resources, utilizing the current measurement gap to perform channel quality measurement.

10. The communication system according to claim 9, wherein each of the one or more UEs is further configured to perform:
determining whether a transmission count or a transmission time reaches a configured upper limit of the predetermined configuration data; and
in response to determining that the transmission count or the transmission time reaches the configured upper limit, performing the channel quality measurement in response to determining that the current measurement gap occurs, and resetting the transmission count or the transmission time.

11. The communication system according to claim 10, wherein each of the one or more UEs is further configured to perform:
determining whether a data delay budget is lower than a budget threshold;
in response to determining that the data delay budget is not lower than the budget threshold, determining whether the current measurement gap occurs, and utilizing the current measurement gap for data transmission in response to determining that the current measurement gap conflicts with any of the plurality of transmission resources;
in response to determining that the data delay budget is lower than the budget threshold, determining whether any of the plurality of transmission resources for uplink is available before the data delay budget is depleted;
in response to determining that the data delay budget is not less than the budget threshold, determining whether the current measurement gap conflicts with any of the plurality of transmission resources;
in response to determining that any of the plurality of transmission resources for uplink is available before the data delay budget is depleted, performing the channel quality measurement when the current measurement gap occurs and the transmission count or the transmission time is determined to reach the configured upper limit; and
in response to determining that any of the plurality of transmission resources for uplink is not available before the data delay budget is depleted, utilizing the current measurement gap for data transmission in response to determining that the transmission count or the transmission time does not reach the configured upper limit.

12. The communication system according to claim 11, wherein the predetermined configuration data defines and indicates the pre-configured transmission strategy, and each of the one or more UEs is configured to perform:
in response to determining that the current measurement gap does not conflict with any of the plurality of transmission resources, determining whether any uplink data or downlink data requires transmission;
in response to determining that the uplink data or the downlink data requires transmission, transmitting the uplink data or the downlink data by utilizing the current measurement gap; and
in response to determining that no uplink data or the downlink data requires transmission, utilizing the current measurement gap to perform the channel quality measurement, and notifying the base station to release the corresponding transmission resources.

13. The communication system according to claim 12, wherein each of the one or more UEs is further configured to perform:
in response to determining that the transmission count or the transmission time reaches the configured upper limit, determining whether a handover event is triggered;
in response to determining that the handover event is triggered, utilizing the current measurement gap to perform the channel quality measurement; and
in response to determining that the handover event is not triggered, utilizing the current measurement gap for uplink data transmission.

14. The communication system according to claim 11, wherein the predetermined configuration data defines and indicates the competitive transmission strategy, and each of the one or more UEs is configured to perform:
in response to determining that the transmission count or the transmission time reaches the configured upper limit, determining whether a handover event is triggered;
in response to determining that the handover event is triggered, transmitting a dynamic data transmission request to the base station, and utilizing the transmission resources that do not conflict with any of the measurement gaps for uplink data transmission; and
in response to determining that the handover event is not triggered, transmitting the dynamic data transmission request for utilizing the current measurement gap to the base station.

15. The communication system according to claim 14, wherein, in response to the UE receiving a notification from the base station for permitting transmission, the current measurement gap is utilized for data transmission; and
in response to the UE not receiving the notification from the base station for permitting transmission, the current measurement gap is utilized to perform the channel quality measurement.

16. The communication system according to claim 9, wherein each of the one or more UEs is further configured to perform:
in response to performing the channel quality measurement in the current measurement time slot, resetting a measurement gap timer or a measurement gap counter to zero; and
in response to the current measurement gap being utilized for data transmission, starting the measurement gap timer or increasing a measurement count of the measurement gap counter by 1.
